(19) United States
(12) Patent Application Publication
(10) Pub. No.: US 2004/0240644 A1
(43) Pub. Date: Dec. 2, 2004

(54) Method for remote configuration of a communication terminal

(76) Inventors: Susanne Stiegel, Mering (DE); Frank Blaimberger, Bobingen (DE); Cristoph Grundel, Munchen (DE); Anton Obermaier, Munchen (DE); Peter Maly, Munchen (DE); Manfred Schacht, Munchen (DE)

Correspondence Address: Bell Boyd & Lloyd LLC, Po Box 1135, Chicago, IL, 60690, US

(21) Appl. No.: 10/489,042

(22) PCT Filed: Sep. 2, 2002
(86) PCT No.: PCT/DE02/03223

(30) Foreign Application Priority Data
Sep. 7, 2001 (DE) 101 44 025.1

(51) Int. Cl. H04M 11/00

(52) U.S. Cl. 379/90.01; 379/93.01

(57) ABSTRACT

Disclosed is a method for remote configuration of a communication terminal and/or connection enabling the device to be connected to a communication network. A call link is set up initially between the device and a service device, whereby the adjustment of a specific feature of the communication terminal and/or the communication connection is requested by a user of the communication terminal. A corresponding function code is interactively transmitted by the service device to the device or network during said call link and the desired adjustment of said feature is carried out using said function code.

### BACKGROUND OF THE INVENTION

The present invention relates to a method for remote configuration of a communication terminal and/or communication connection via which the device is connected to a communication network. The present invention also relates to a communication terminal, a service device, and a system including at least one communication terminal and one service device, for implementing the method according to the present invention.

Many communication terminals such as, for example, modern fixed network terminals, mobile telephones, or other devices connected to a communication network, such as PCs, PDAs, organizers or a combination of these various devices, have a multitude of adjustable features which, when properly adjusted and implemented, are highly convenient and extremely useful to the user. These adjustable features include not only performance features, such as the various functions and parameters of the device itself, but also the service and performance features of the connection, which are supported by the network operator and must be requested from the operator by programming the terminal accordingly. Such features include, for example, external call diversion, setting up of a conference call, or withholding of the caller's own number on outgoing calls. In many cases, adjusting the features properly is not a simple task. This is particularly true for smaller communication terminals, such as telephones, whose user interfaces must be accommodated on a small area and which are often adjusted by pressing a combination of different keys. Such adjustments are, however, particularly difficult if a combination of symbol keys such as “*” or “#” and various digit keys must be pressed in a specific sequence in order to carry out the adjustment.

Today, however, more user-friendly terminals often have a user interface with a display, and the user is guided through the adjustment process by a menu on the display. Yet, even in such devices with menu-prompted programming facilities, the complexity and great variety of functions results in many users, such as elderly or disabled persons, not being expected to configure their device and their connection to their requirements by themselves, whereby these users require assistance with adjusting their device. One possibility is for them to call upon service personnel from the device manufacturer or from a dealer, but this is costly and not really the responsibility of the manufacturer or the dealer, since the device itself is not defective. A known method of simplifying configuration for the user is to provide various default configuration profiles which are required relatively frequently by users. Such a profile is loaded into the communication terminal or called up from a memory by the user. This may be done at the factory or by the dealer before the device is transferred to a customer. If a personalized configuration is required, however, users must be able to adjust the individual features of the device or connection themselves.

It is also known for larger data processing and/or telephone systems in companies to be maintained remotely, via a data line, by a service company, usually the local dealer that installed the system. This is relatively time-consuming and expensive for the user such that these methods are not particularly suitable for an end-user who, for example, merely wishes to have the volume of his/her telephone adjusted.

An object of the present invention is, therefore, to create an alternative to this prior art, whereby a user may be assisted in adjusting his or her device or connection, in a simple manner, from a different location; i.e., elsewhere from the terminal device or connection to be configured.

### SUMMARY OF THE INVENTION

In the method according to the present invention, a call link is set up initially between the communication terminal concerned, which the user wishes to configure, and a service device via the communication network. This call link is maintained throughout the configuration process and the user can verbally request the service device, via this call link, to implement an adjustment for a specific performance or service feature of the terminal and/or the communication connection; for example, the volume adjustment for the terminal or activation of a call forwarding function.

The service device end may include real service personnel who meet the user's wishes and arrange the configuration of the terminal or connection from there accordingly. However, the service device may also be an automatic device with voice recognition and voice output, so that the user can communicate with the device as if it were a real person.

An important aspect is that a function code corresponding to the desired adjustment of the feature is interactively transmitted by the service device to the communication terminal and/or a connection control device of the communication network during the call link.

This connection control device is generally a device within the network which controls the features (i.e., the parameters and functions) of the relevant communication connection for the terminal. It may be implemented in the network in various ways. In particular, the connection control device may consist of several control units which are distributed within the network and which handle the various tasks involved in controlling the connection. In this case, it is the same device that users themselves contact when configuring the connection from the terminal. The difference in the method according to the present invention is that the signals required for the configuration are transmitted for the terminal by the service device and not by the communication terminal.

The transmitted function code is then detected by the communication terminal and/or the connection control device of the communication network, whereupon the desired feature adjustment is carried out. In this case, the function code must be detected at least to the extent that the terminal detects whether it is a function code provided for the network operator for adjusting a feature of the connection, or whether it is a function code for adjusting a feature inside the terminal which is to be changed.

Implementation of the method firstly requires a communication terminal which as well as having the capability of setting up a call link between the communication terminal and the service device, in order to provide the desired adjustment of the features on the terminal or connection, also has the capability of receiving the function code from the service device during the call link. In addition, a device is required in order to detect a received function code and then to arrange the desired adjustment of the feature in the communication terminal. This may be done, for example, by converting the function code into an internal control signal and transmitting it to the required component. For example, to adjust the display brightness, the control signal is transmitted to the power control input of an illumination unit.

Secondly, a service device is required which also has the capability of setting up a call link between the communication terminal and the service device and, in addition, a transmission device for transmitting corresponding function codes to the communication terminal and/or to the connection control device which controls the connection of the communication terminal during the call link.

Various options exist for the transmission of the function code during the call link, depending on the particular communication terminal and communication connection or communication network.

In one embodiment, the function code may be transmitted via a second channel, preferably a data channel, which is set up in parallel to the first channel which forms the call link. In this case, both the terminal and the connection, as well as the service device, must be able to set up and operate at least two parallel channels between these two devices. This happens, for example, in the case of ISDN connections. In this case, any function codes may be sent via the second channel, and these can be detected, separated and processed as function codes relatively easily in the terminal.

In a particularly advantageous embodiment of the present invention, however, the function code is transmitted directly alongside the voice data via the channel for the call link and separated from the voice data via a filter unit in the terminal.

This method firstly requires suitable, special function codes, which can easily be separated from the voice data, to be fed into the voice channel. At the terminal end, a corresponding filter is required for detecting the function codes among the voice data within the voice channel and filtering them out as necessary. The method works to best advantage, however, in simple analog connections.

This is particularly useful, since experience shows that the very persons who require help with configuring a terminal, such as elderly people, often have only a simple connection. A further advantage of this method, even if it is used on connections with several channels, is that only one channel is required, whereby there is no additional burden on the communication network or increased connection costs as a result of the remote configuration.

A service device may also have parts for transmitting the function code either via a separate channel, where this is possible at the terminal end, or, alternatively, via the voice channel. Such a service device is, accordingly, able to adapt to the terminal or connection to be configured and to select the most effective transmission method. A communication terminal according to the present invention likewise also can be constructed such that both transmission methods may be used.

To prevent the filter remaining active even during a normal call link between the terminal and other subscribers or devices, and possibly filtering out signals from the call link channel unnecessarily, in a preferred exemplary embodiment of the present invention an activation code is transmitted by the service device to the communication terminal as the initial function code after the call link is set up between the communication terminal and the service device. This activation code activates the filter unit. Then, before the call link is terminated, a deactivation code which deactivates the filter unit again is transmitted by the service device as the final function code. Alternatively, the filter unit may also be deactivated automatically when the call link is interrupted.

In a particularly preferred exemplary embodiment of the method according to the present invention, the function codes are transmitted in the form of DTMF (Dual-Tone-Multi-Frequency) signals. These DTMF tones occupy a higher frequency range than normal voice signals, which occupy a frequency range of 300 to 3 kHz. They are, therefore, relatively easy to detect and can also be easily filtered out.

When such DTMF signals are used, there is also a particular advantage in the fact that the filtering out process takes place after activation of the filter unit at the start of a call link between the communication terminal and the service device and before the final deactivation, in that the user does not have to listen to the DTMF signals during the entire configuration process, as this can impair the voice quality.

Various options likewise exist for transferring the function codes for adjusting a feature of the communication connection to the relevant connection control device in the network.

In one exemplary embodiment of the present invention, a function code is transmitted by the service device and received by the communication terminal irrespectively of whether it is a function code for adjusting a feature of the connection or of the communication terminal itself. The communication terminal then detects whether the function code is for adjusting a feature of the terminal itself or for adjusting a connection feature. In the first case, the function code is processed in the communication terminal itself. In the second case, the function code is forwarded by the communication terminal to the connection control device of the communication network. Alternatively, a corresponding control signal may also be transmitted from the communication terminal to the connection control device. As such, for example, the service device converts the function code into a control signal that the connection control device understands, and then transmits this control signal.

In this case, of course, the communication terminal must have a corresponding part for forwarding a detected function code for adjusting a connection feature to the connection control device, or for converting the function code into a control code suitable for the connection control device and transmitting it to the connection control device.

However, since the call link is implemented via the communication connection of the relevant communication network anyway, in a preferred exemplary embodiment of the present invention the connection control device of the communication network automatically detects and processes a function code destined for it. In the communication terminal, it then only remains necessary to detect whether the transmitted function code is a function code for adjusting a feature of the terminal itself. Only in this case is the function code used accordingly in the communication terminal for adjusting a feature. Otherwise, this function code is ignored.

In the method according to the present invention, most configuration adjustments of the terminal or of the connection, such as, for example, call group allocation, MSN (Multiple Subscriber Number) entries, or even adjustment of any integrated call answering devices, may be carried out online. The method also has the particular advantage that a user can check the change to a feature immediately and either confirm it or request a new change. This applies, for example, to the adjustment of features such as volume, ringtone settings, or display brightness, etc.

The inventive method is also relatively simple and cost-effective and requires no expensive modifications inside the terminal. A corresponding service device likewise can be set up with simple resources. If a corresponding number of connections and service personnel staff and/or automatic systems with voice interfaces running in parallel are also able to adjust several terminals at the same time, more users can be served at the same time.

Additional features and advantages of the present invention are described in, and will be apparent from, the following Detailed Description of the Invention and the Figures.

### BRIEF DESCRIPTION OF THE FIGURES

FIG. 1 is a schematic flowchart showing the method according to the present invention.

FIG. 2 is a schematic block diagram showing a control device in a communication terminal according to the present invention.

FIG. 3 is a time scheme showing the sequence of signals in the method according to the present invention.

### DETAILED DESCRIPTION OF THE INVENTION

The exemplary embodiment shown in the diagrams relates to a method which requires only one voice channel and in which the function codes are transmitted during the call on the voice channel in the form of DTMF tones. The method shown, therefore, can be used with any terminals, i.e. even with simple terminals; i.e., in an analog network.

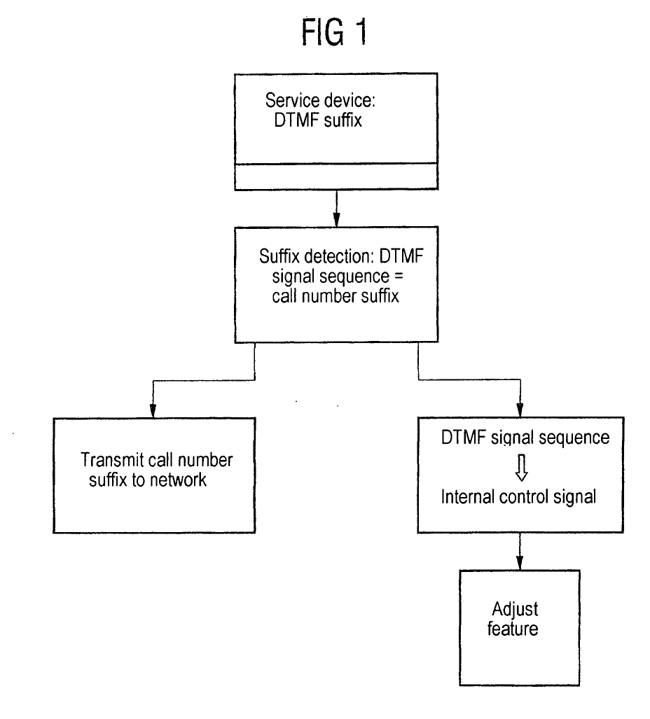

FIG. 1 shows a typical execution of the method in a terminal, starting with the transmission of a DTMF signal from the service device to the terminal.

In the first stage, a DTMF signal sequence F is transmitted by the service device as a function code F. So-called suffix detection is carried out at the terminal end, whereby the terminal checks whether the transmitted DTMF signal sequence F is a defined call number suffix; i.e., a service sequence defined by the network operator as a service sequence for configuring a connection. If so, this function code is to be used accordingly for configuring the connection. As such, for example, it might be a function code for releasing or blocking a specific service feature by the operator; e.g., withholding of the call number, setting up of a collect call, or setting up of a conference call. This call number suffix is then looped through by the terminal and transmitted to the network. Ideally, a negative acknowledgment is sent as well, so that the network recognizes that it is a signal which is destined for the network.

If the transmitted DTMF signal sequence F is not recognized as a defined service sequence of the network, it is processed further in the device and, for example, converted into an internal control signal C, which is used in the device for adjusting the relevant feature. In this case, for example, the DTMF signal sequence F may be converted into a menu short-cut C, which the user would otherwise have to key in if he/she were configuring the device himself/herself. The converted control signal C is then further processed in the device in the usual way and the desired feature is thus changed; for example, the volume is increased or reduced or a specific ringtone or internal call forwarding is set.

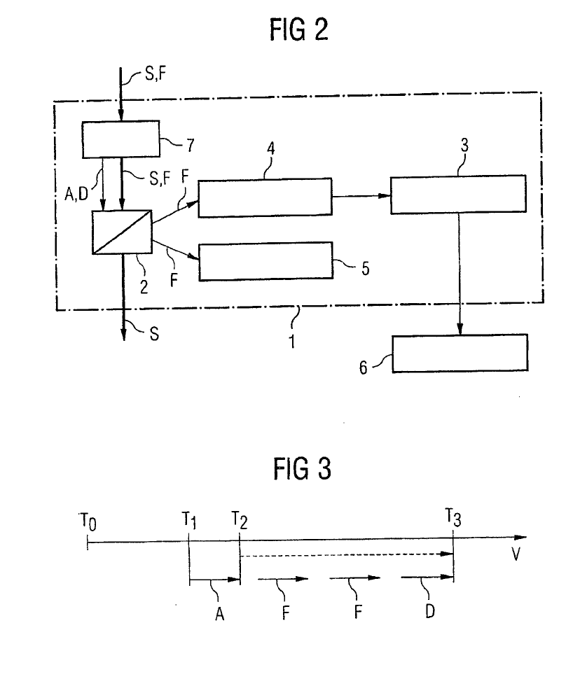

FIG. 2 is a schematic diagram showing the main components of a remote control unit 1 of a terminal that are required for implementation of the method according to the present invention, and their interconnection.

The remote control unit 1 may be disposed as a contiguous unit in the terminal. However, it may also be formed from one or more separate components, whereby individual components may also belong to other functional units of the device and may only be used jointly by the remote control unit. In particular, many components may also be implemented at the software level; for example, in a general control unit of the device or in a CPU.

A main element of the remote control unit 1 is a filter unit 2. This filter unit 2 is located, for example, in a receiving device (not shown) of the mobile telephone. The voice data S and the DTMF signal sequences F are fed into the filter unit 2 on the input side. The DTMF signal sequences F are filtered out when the filter unit 2 is activated, whereas the voice data 3 is looped through and processed within the terminal in the usual way.

The filter unit 2 is connected in series to a detector unit 7 on the input side. This detector unit 7 serves to detect a special function code which is intended to act as an activation code A or as a deactivation code D for the filter unit 2. As soon as an activation code A is detected, the filter unit 2 is automatically activated by the detector unit 7 so that it performs its filtering function. When the filter unit 2 is active, the user no longer hears the DTMF signal sequences F. When a deactivation code D is detected, the filter unit 2 is deactivated accordingly and all signals, including the DTMF signal sequences F, are looped through by the filter unit 2 so that they can be heard again by the user.

In this exemplary embodiment, the filter unit 2 also serves to detect whether a filtered out DTMF signal sequence F is a call number suffix which is intended for the network or the connection control of the network, in order to adjust a connection feature. In this case, the signal is routed to a suffix transmission device 5, which ensures that the call number suffix is transmitted back to the network and processed there. This suffix transmission device 5 mainly acts as a link to the transmission device (not shown) of the communication terminal, in order to forward the DTMF signal sequence F from there to the network.

As long as the DTMF signal sequence F is not identified as a call number suffix of the network, it is initially stored in a buffer memory 4 and then converted inside a conversion device 3 into an internal control signal C of the terminal. The buffer memory 4 is optional in this case. Thus, it is also possible to forward the DTMF signal sequence F immediately to the conversion device 3. An essential component contained in the conversion device is a DTMF sequence comparison table, in which different DTMF signal sequences are stored and internal control signals C, such as menu short-cuts, are allocated. The conversion is thus performed simply by checking against the values in this table.

The control signal C detected in the conversion device 3 is then forwarded to the corresponding function unit 6, which is responsible for amending the required feature. This may, for example, be a display control, a volume control, or even the general device control 6 (for example, a CPU of the device) which then arranges for the required feature to be adjusted accordingly in the device.

FIG. 3 again demonstrates the chronological sequence of the individual signals.

First of all, a call link V is set up at a point in time T0. After the user has expressed his or her adjustment requirement to the service device, such as to the service personnel staffing it, the service device first transmits an activation code A in the form of a DTMF signal sequence. This takes place at the point in time T1. In this instance, after this activation code A is detected the filter device 2 is activated in the communication terminal of the user at the point in time T2, so that the user no longer hears DTMF signal sequences being transmitted. The first DTMF signal sequence may be understood by the user as an acknowledgment which enables the user to check that the remote configuration service is active; for example, following an explanation to this effect by the service personnel. The dotted arrow in FIG. 3 shows the period during which the filter device is active.

The necessary function codes F, which adjust the device or the connection in the required way, are then transmitted by the service device in the form of further DTMF signal sequences F.

Meanwhile, the user may communicate with the service device at any time and may express further requirements or even have any adjustments changed again immediately after checking them. The user is thus able, with the help of the service device, to have his or her device configured interactively without the service personnel having to go to the user and the device, or the user having to take the device to a service center.

This is particularly advantageous if the user wishes to change a parameter but is not able to specify precise settings for the modification. One example of this is modification of the ring tone volume. In this case, the user can simply notify the service device that he or she would like the ring tone to be slightly louder. The service device then sends the corresponding function code to the terminal. The user can check the modification immediately and either confirm it or request a new volume adjustment, whereupon a new function code is transmitted accordingly by the service device. If the user is satisfied with the adjustment and confirms it, the modification is finally stored in the device; for example, by a further function code.

Finally, a function code is transmitted as a special deactivation code D, which ensures that the filter unit 2 is deactivated at the point in time T3, and thus the terminal is back in its original status in which DTMF signals arriving over the call link are again acoustically output to the user. Only then is the call link interrupted, whereupon the remote configuration is concluded.

Although the present invention has been described with reference to specific embodiments, those of skill in the art will recognize that changes may be made thereto without departing from the spirit and scope of the present invention as set forth in the hereafter appended claims.

1-17 (canceled)

18. A method for remote configuration of at least one of a communication terminal and a communication connection via which the communication terminal is connected to a communication network, the method comprising the steps of:
initially setting up a call link, via which a user of the communication terminal requests an adjustment to a specific feature of the respective communication terminal or communication connection, between the communication terminal and a service device;
interactively transmitting a function code corresponding to the requested adjustment of the feature, during the call link, by the service device to the respective communication terminal or a connection control device of the communication network, the function code controlling the communication connection of the communication terminal, wherein the function code is transmitted via a second channel set up in parallel to a first channel forming the call link;
detecting the function code by the respective communication terminal or connection control device of the communication network; and
carrying out the requested adjustment of the feature in the respective communication terminal or by the connection control device of the communication network.

19. A method for remote configuration of at least one of a communication terminal and a communication connection via which the communication terminal is connected to a communication network as claimed in claim 18, wherein the function code is transmitted via the first channel alongside voice data and is separated from the voice data via a filtered unit.

20. A method for remote configuration of at least one of a communication terminal and a communication connection via which the communication terminal is connected to a communication network as claimed in claim 19, wherein after the call link has been set up between the communication terminal and the service device, an activation code, with which the filter unit is activated, is transmitted as an initial function code from the service device to the communication terminal.

21. A method for remote configuration of at least one of a communication terminal and a communication connection via which the communication terminal is connected to a communication network as claimed in claim 20, wherein before termination of the call link, a deactivation code, with which the filter unit is deactivated, is transmitted as a final function code from the service device to the communication terminal.

22. A method for remote configuration of at least one of a communication terminal and a communication connection via which the communication terminal is connected to a communication network as claimed in claim 18, wherein the function code is transmitted in the form of a DTMF signal.

23. A method for remote configuration of at least one of a communication terminal and a communication connection via which the communication terminal is connected to a communication network as claimed in claim 18, wherein the function code is transmitted by the service device and received by the communication terminal, and the communication terminal detects whether the transmitted function code is for adjusting a feature of the communication terminal or for adjusting a feature of the communication connection, and wherein if the function code is a function code for adjusting a feature of the communication terminal, the function code is used in the communication terminal for adjusting the feature and, if the function code is for adjusting a feature of the communication connection, the function code is forwarded by the communication terminal to the connection control device of the communication network or a corresponding control signal is sent by the communication terminal to the connection control device.

24. A method for remote configuration of at least one of a communication terminal and a communication connection via which the communication terminal is connected to a communication network as claimed in claim 18, wherein the function code is transmitted by the service device and the connection control device of the communication network automatically detects and processes the function code destined thereto, and the communication terminal detects whether the transmitted function code is for adjusting a feature of the communication terminal and, only if so, the function code is used in the communication terminal for adjusting a feature.

25. A communication terminal for effecting a method for remote configuration of at least one a communication terminal and a communication connection via which the communication terminal is connected to a communication network, comprising:
parts for setting up a call link between the communication terminal and a service device, for allowing an adjustment to be carried out as requested by a user, to a specific feature of the respective communication terminal or communication connection via which the communication terminal is connected to a communication network;
parts for setting up a second channel between the communication terminal and the service device for transmitting a function code in parallel to a first channel set up for the call link;
parts for receiving the function code from the service device during the call link; and
a device for detecting a received function code and to thereafter arrange the desired adjustment of the feature.

26. A communication terminal for effecting a method for remote configuration of at least one a communication terminal and a communication connection via which the communication terminal is connected to a communication network as claimed in claim 25, further comprising a filter device for separating the function code, which is transmitted via the first channel for the call link alongside voice data, from the voice data.

27. A communication terminal for effecting a method for remote configuration of at least one a communication terminal and a communication connection via which the communication terminal is connected to a communication network as claimed in claim 26, wherein the filter device includes a device for filtering out DTFM signals from a voice channel.

28. A communication terminal for effecting a method for remote configuration of at least one a communication terminal and a communication connection via which the communication terminal is connected to a communication network as claimed in claim 26, wherein the filter device is at least one of activated and deactivated by the service data via corresponding function codes.

29. A communication terminal for effecting a method for remote configuration of at least one a communication terminal and a communication connection via which the communication terminal is connected to a communication network as claimed in claim 25, further comprising a device for detecting whether a transmitted function code is for adjusting a feature of the communication terminal or for adjusting a feature of the communication connection.

30. A communication terminal for effecting a method for remote configuration of at least one a communication terminal and a communication connection via which the communication terminal is connected to a communication network as claimed in claim 29, further comprising parts for forwarding a detected function code for adjusting a feature of the communication connection to a connection control device of the communication network, which controls the communication connection of the communication terminal, or for transmitting a corresponding control signal from the communication terminal to the connection control device of the communication network.

31. A service device for remote configuration of at least one of a communication terminal and a communication connection via which the communication terminal is connected to a communication network, comprising:
parts for setting up a call link between the communication terminal and the service device, for allowing an adjustment to be carried out, as requested by a user of the communication terminal, to a specific feature of at least one of the communication terminal and the communication connection via which the communication terminal is connected to the communication network;
a transmission device for transmitting a function code during the call link, the function code corresponding to the requested adjustment of the feature to at least one of the communication terminal and a connection control device of the communication network which controls the communication connection of the communication terminal; and
parts for setting up a second channel, between the communication terminal and the transmission device for transmitting the function code, in parallel to a first channel set up for the call link.

32. A service device for remote configuration of at least one of a communication terminal and a communication connection via which the communication terminal is connected to a communication network as claimed in claim 31, wherein the transmission device may transmit the function code along side voice data via the first channel for the call link.

33. A service device for remote configuration of at least one of a communication terminal and a communication connection via which the communication terminal is connected to a communication network as claimed in claim 32, wherein the transmission device may transmit a DTMF signal as a function code via a voice channel.

34. A system for remote configuration of at least one of a communication terminal and a communication connection via which the communication terminal is connected to a communication network, the system comprising:
a communication terminal which includes: parts for setting up a call link between the communication terminal and a service device, for allowing an adjustment to be carried out, as requested by a user of the communication terminal, to a specific feature of at least one of the communication terminal and the communication connection via which the communication terminal is connected to the communication network; parts for receiving a function code from the service device during the call link; a device for detecting a received function code and to thereafter arrange the requested adjustment of the feature; and parts for setting up a second channel between the communication terminal and the service device for transmitting a function code in parallel to a first channel set up for the call link; and
a service device which is connected to the communication terminal via the call link, the service device including a transmission device for transmitting the function code, during the call link, corresponding to the requested adjustment of the feature to at least one of the communication terminal and a connection control device of the communication network which controls the communication connection of the communication terminal.

35. A system for remote configuration of at least one of a communication terminal and a communication connection via which the communication terminal is connected to a communication network, the system comprising:
A communication terminal which includes: parts for allowing a user of the communication terminal to request that an adjustment be made to a specific feature of at least one of the communication terminal and the communication connection via which the communication terminal is connected to the communication network; parts for receiving a function code from the service device during a call link; and a device for detecting a received function code and to thereafter arrange the requested adjustment of the feature; and
A service device which is connected to the communication terminal via the call link, the service device including: parts for setting up the call link between the communication terminal and the service device, and for allowing the requested adjustment to be carried out; a transmission device for transmitting the function code during the call link, the function code corresponding to the requested adjustment of the feature to at least one of the communication terminal and a connection control device of the communication network which controls the communication connection of the communication terminal; and parts for setting up a second channel, between the communication terminal and the transmission device for transmitting the function code, in parallel to a first channel set up for the call link.
